(19) United States
(12) Patent Application Publication
(10) Pub. No.: US 2008/0246282 A1
(43) Pub. Date: Oct. 9, 2008

(54) System and method for generating residential hydropower

(76) Inventors: Philip John Hathaway, Bryan, TX (US); Philip Jeffrey Hathaway, Bryan, TX (US); Jennifer Ann Hathaway, Bryan, TX (US)

Correspondence Address: Andrew G. DiNovo;DINOVO PRICE ELLWANGER LLP, P.O. BOX 201690, Austin, TX, 78720, US

(21) Appl. No.: 11/786,062

(22) Filed: Apr. 9, 2007

(51) Int. Cl. F03B 13/00

(52) U.S. Cl. 290/54

(57) ABSTRACT

A system and method are disclosed for generating small-scale hydropower from a home water supply. As contemplated herein, a hydro-powered system battery charger may produce electric power from the flow of water from a domestic water service. Power is generated as water from a domestic water source passes through a system housing. The water drives a Pelton wheel located within a cavity in the housing. As the Pelton wheel rotates, it drives a gear driven generator. A battery may store the energy generated thereby to satisfy concurrent or later demand.

### FIELD OF THE INVENTION

The present invention relates generally to the fields of energy generation, and more particularly to a system and method for generating hydropower from the water supply to an existing home or other structure.

### BACKGROUND OF THE INVENTION

Energy production and use have emerged as critically important issues facing this and other developed countries. As recoverable fossil fuels are depleted and negative externalities associated with their use continue to mount, governments and others increasingly focus on renewable energy resources as a means of reducing our reliance on fossil fuels.

Generally speaking, renewable energy is energy derived from resources that are regenerative or, for all practical purposes, cannot be depleted. For this reason, renewable energy sources are fundamentally different from fossil fuels and do not produce as many greenhouse gases and other pollutants as fossil fuel combustion.

Mankind's traditional uses of wind, water, and solar energy arc widespread in developed and developing countries; but the mass production of electricity using renewable energy sources has become more important recently, reflecting the major threats of climate change due to pollution, exhaustion of fossil fuels, and the environmental, social and political risks of fossil fuels arid nuclear power.

It is well known that energy present in water (in the form of motive energy or temperature differences) can be harnessed and used. Since water is about a thousand times denser than air, a flowing stream of water or sea swell can yield considerable amounts of energy.

There are many forms of water energy production, including hydroelectric and micro hydro. Hydroelectric energy is a term usually reserved for large-scale hydroelectric dams. Micro-hydro systems are hydroelectric power installations that typically produce up to 100 kW of power. They are sometimes used in water-rich areas as a Remote Area Power Supply (RAPS).

Despite the benefits and advantages of the foregoing, existing hydropower solutions, including RAPS, are not readily applicable to a conventional home water source. They are instead directed to production of electricity on a larger scale with heavy, cumbersome and expensive equipment which are prohibitive to a home user, for example. Thus, one object of the present invention is to provide a hydropower generation system that is comparatively simple and inexpensive to deploy on a widespread basis.

In view of the foregoing, a system and method are disclosed for producing, storing, and utilizing hydropower using a home water supply. Potential advantages of the present invention include the collection of energy for contemporaneous or later use and the charging or recharging of battery-based systems in the home.

### SUMMARY OF THE INVENTION

A system and method for generating small-scale, inexpensive hydropower is presented. The device can be used in tandem with the local residential electrical supply by having a centrally-located battery area in the home that would have multiple rechargeable batteries that would service the home's needs when they were fully-charged in addition to the city's electrical supply, thereby reducing electrical demand.

As contemplated herein, a hydro-powered system battery charger may produce electric power from the flow of water from a domestic water service. Power is generated as water from a domestic water source passes through a system housing. The water drives a Pelton wheel located within a cavity in the housing. As the Pelton wheel rotates, it drives a gear-driven generator. The energy may be stored locally in one or more batteries for simultaneous or later use.

In a preferred embodiment, the overall design is small, relatively inexpensive, and simple to install in the home or commercial environment.

### BRIEF DESCRIPTION OF THE DRAWINGS

The foregoing and other advantages of the invention will become apparent upon reading the following detailed description and upon reference to the drawings, wherein:

FIG. 1 illustrates an exploded view of a system in accordance with one aspect of the present invention.

FIG. 2 is a top-down view depicting the system in FIG. 1 as assembled and in use.

FIG. 3 is a cross-sectional view of the system shown in FIGS. 1 and 2.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

As set forth above, embodiments of the invention provide a system and method for generating hydropower from the water supply in a home or other building.

A hydropower resource can be measured according to the amount of available power or energy per unit time. The power is a function of the hydraulic head and rate of fluid flow. With water in a reservoir, the head is the height of water in the reservoir relative to its height after discharge. Each unit of water can produce a quantity of work equal to its weight times the head.

The amount of energy E released by lowering an object of mass m by a height h in a gravitational field is:

E=mgh, where g is the acceleration due to gravity.

The energy available to hydroelectric dams is the energy that can be liberated by lowering water in a controlled way. In these situations, the power is related to the mass flow

$$\frac{E}{t} = \frac{m}{t} … gh$$

rate.

Substituting P for E/t and expressing m/t in terms of the volume of liquid moved per unit time (the rate of fluid flow φ) and the density of water, we arrive at another form of this expression:

P=pφg·h

For P in watts, p is measured in kg/m³, φ is measured in m³/s, g is measured in m/s², and h is measured in meters.

Some hydropower systems such as water wheels can draw power from the flow of a body of water without necessarily changing its height. In this case, the available power is the kinetic energy of the flowing water.

$$P = \frac{1}{2} … p ϕ t {\cdot }^{2}$$

,where v is the velocity of the water,

or with,

$$P = \frac{1}{2} … p ϕ = A \cdot t {\cdot }^{3}$$

where A is the area through which the water passes, also

$$P … = … \frac{1}{2} … p A \cdot t {\cdot }^{3}$$

System Design

In a preferred embodiment, a system in accordance with the present invention includes an electrical generation system electrically coupled to a battery charger that may be applied to any number of types of batteries needed to operate appliances, electronics and other devices.

A train supply pipe connected to the water company's main or to a well on property generally supplies water to a house. That water is typically under moderately high pressure, as exhibited by the sight of water gushing from a fire hydrant.

Once the water arrives to a house, the main supply generally divides into one system of pipes for cold water and another for hot water. Waste drainage systems take advantage of gravity to channel waste to the sewer line. The soil stack, a vertical run of pipe three to four inches in diameter, carries waste to a main drain usually underneath the house which empties to a sewer or septic tank.

Generally speaking, a pipe's size and material can often serve as a fairly good indicator of its function. White plastic, copper, and galvanized (silver-toned) pipes that are from ½ inch to 1 inch in diameter generally carry water, though some galvanized steel, black steel, and flexible copper pipes of the same sizes may carry gas. Large-diameter (1½ inch and larger) black plastic, cast-iron, and copper are often drain-waste-vent pipes.

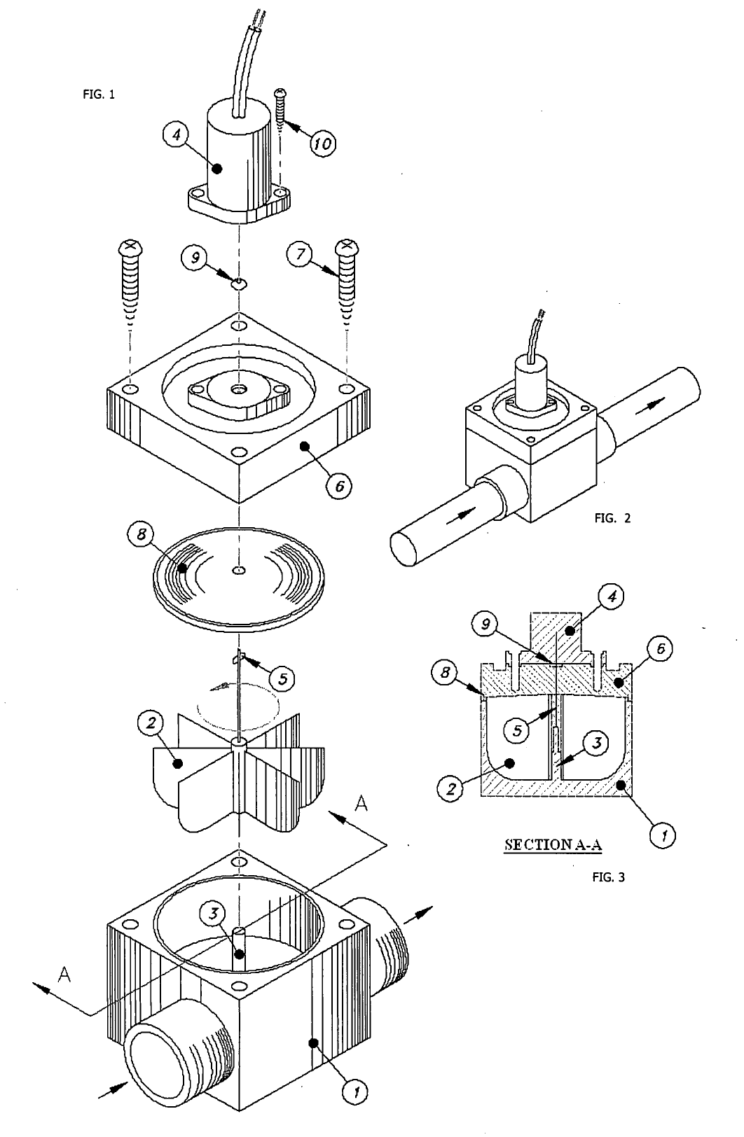

As noted, the hydro-powered system battery charger may produce electric power from the flow of water from a domestic water service. Referring now to FIGS. 1 and 3, power is generated as water from a domestic water source passes through the system housing 1. As water passes through the system, it drives/rotates a Pelton wheel 2 mounted on a centering rod 3 located within a cavity in the housing. As the Pelton wheel rotates, it drives a gear-driven generator 4 by the means of a pin 5 connected to the Pelton wheel and inserted into the generator base. The housing cap 6 will enclose the system and will be attached to the housing with heavy-duty screws 7.

Water leaks will be contained by utilizing a gasket 8 and an “O” ring 9 inserted between the housing and cap and between the cap and the generator. The generator will be attached to the cap with smaller 10 heavy-duty screws. Electric power generated by the system can be utilized to energize a multitude of battery chargers.

FIG. 2 shows water flowing through the system of FIG. 1 when assembled.

FIG. 3 depicts a cross section of the exemplary system shown in FIG. 1.

Exemplary Applications of the Invention

The device can be used in tandem with local residential electrical supply by having a centrally located battery area in the home that would have multiple rechargeable batteries that would service the home when they were fully charged in lieu of the city's electrical supply.

In art alternative embodiment, the device can be implemented in a smaller size throughout a home for charging of other appliances and batteries (e.g., cell phones, cameras, video games, televisions, MP3 players and computers. In another embodiment, the device is installed in an application-specific fashion, such as for the purpose of recharging the battery of a local appliance. In another embodiment, the system is installed to power emergency devices when electric power is not available. In this embodiment, the failure of electrical power is sensed, and the system is engaged to generate electricity for lighting, powering a radio or other communication equipment.

The system may also be used in connection with irrigation systems outside or without connection to a structure. For example, battery-powered irrigation controllers are often utilized to direct watering systems on golf courses, cemeteries and other irrigated grounds. Such a controller is often battery-driven, and capable of operating a finite number of valves within a subject area. The expected lifespan of such a battery is often less than a year. With the installation of a hydro powered battery charger in accordance with the present invention, a nickel-cadmium battery can be recharged each time the system is in operation thus reducing maintenance and extending the life of the battery.

During storms, floods, tornadoes, earthquakes and other power outages, the system and method described herein can be advantageously utilized to help provide backup power until local service could be restored.

The foregoing discussion focuses principally on the generation of hydropower from the water supply to a home. It will be understood by those of skill in the art, however, that other applications of this invention will also be useful. For example, the system can be used in commercial or industrial applications to extend battery life for devices deployed where electricity in not readily available, or a reduction in energy usage is desired.

As noted above, while the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A system for generating hydropower from a domestic water supply having a directional flow comprising:
a system housing having disposed in-line with said domestic water supply, said system housing having a water ingress and water egress corresponding to said directional flow;
a centering rod projecting generally perpendicularly to said directional flow;
a Pelton wheel within said system housing and mounted so as to rotate around said centering rod;
a gasket disposed between said Pelton wheel and an interior side of said system housing; and
a generator coupled to said Pelton wheel so as to generate electrical current upon the rotation of said Pelton wheel.

2. The system of claim 1, further comprising a battery charger electrically coupled with said generator for using said electrical current to charge a battery.

3. The system of claim 1, wherein said generator is coupled to said Pelton wheel by a pin, said pin concentric with said Pelton wheel and projected into said generator.

4. The system of claim 1, further comprising a housing cap forming at least part of said interior side.

5. The system of claim 1, wherein said water ingress is approximately one inch.

6. The system of claim 1, wherein said water ingress is less than one inch.

7. The system of claim 1, wherein said water ingress is approximately one half inch.

8. The system of claim 1, wherein said water ingress is less than one half inch.

9. A, method for generating hydropower from a domestic water supply comprising:
locating a domestic water supply line having a directional flow and a diameter equal to or less than one inch;
installing in-line with said water supply line a power generation system comprising:
a water ingress and water egress corresponding to said directional flow;
a centering rod projecting generally perpendicularly to said directional flow;
a Pelton wheel within said system housing and mounted so as to rotate around said centering rod; and
a gasket disposed between said Pelton wheel and an interior side of said system housing; and
a generator coupled to said Pelton wheel so as to generate electrical current upon the rotation of said Pelton wheel;
generating hydropower electricity from said directional flow; and
storing said hydropower electricity in a battery.

10. The method of claim 9, wherein said generator is coupled to said Pelton wheel by a pin, said pin concentric with said Pelton wheel and projected into said generator.

11. The method of claim 9, wherein said power generation system further comprises a housing cap forming at least part of said interior side.

12. The method of claim 9, wherein said water ingress is less than one inch.

13. The method of claim 9, wherein said water ingress is approximately one half inch.

14. The method of claim 9, wherein said water ingress is less than one half inch.
